(19) United States
(12) Patent Application Publication
(10) Pub. No.: US 2022/0046448 A1
(43) Pub. Date: Feb. 10, 2022

(54) COMMUNICATION METHOD AND TERMINAL FOR PERFORMING THE SAME

(71) Applicant: Samsung Electronics Co., Ltd., Gyeonggi-do (KR)

(72) Inventors: Haijie QIU, Beijing (CN); Xutao ZHOU, Beijing (CN); He WANG, Beijing (CN); Yunchuan YANG, Beijing (CN); Yankun LI, Beijing (CN)

(21) Appl. No.: 17/393,939

(22) Filed: Aug. 4, 2021

(30) Foreign Application Priority Data
Aug. 6, 2020 (CN) 202010785084.X

(51) Int. Cl. H04W 24/08; H04L 5/00

(52) U.S. Cl. CPC H04W 24/08; H04L 5/0048

(57) ABSTRACT

The present disclosure relates to a pre-5th-Generation (5G) or 5G communication system to be provided for supporting higher data rates Beyond 4th-Generation (4G) communication system such as Long Term Evolution (LTE). A communication method and a terminal in a communication system are provided. The terminal determines multiple quasi co-location (QCL) information and information indicating a transmission state corresponding to a same downlink signal. The terminal measures and estimates a downlink channel state according to the determined multiple QCL information. The terminal demodulates the same downlink signal according to the information of multiple QCL, the information indicating the transmission state, and the downlink channel state.

### PRIORITY

This application claims priority under 35 U.S.C. § 119(a) to Chinese Patent Application No. 202010785084.X, filed in the Chinese Intellectual Property Office on Aug. 6, 2020, the entire disclosure of which is incorporated herein by reference.

### BACKGROUND

### 1. Field

The disclosure relates generally to a technical field of wireless communication, and more particularly, to a communication method and a terminal performing the same.

### 2. Description of Related Art

In order to meet the increasing demand for wireless data communication services since the deployment of 4G communication systems, efforts have been made to develop improved 5G or pre-5G communication systems. Therefore, 5G or pre-5G communication systems are also referred to as “beyond 4G networks” or “post-LTE systems”.

In order to achieve a higher data rate, 5G communication systems are implemented in higher frequency (millimeter, mmWave) bands (e.g., 60 GHz bands). In order to reduce propagation loss of radio waves and increase a transmission distance, technologies such as beamforming, massive multiple-input multiple-output (MIMO), full-dimensional MIMO (FD-MIMO), array antenna, analog beamforming, and large-scale antenna, are discussed in 5G communication systems.

In addition, in 5G communication systems, system network improvements are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FOAM) and sliding window superposition coding (SWSC) have been developed as advanced coding modulation (ACM), and filter bank multicarrier (FBMC), non-orthogonal multiple access (NOMA) and sparse code multiple access (CMA) have been developed as advanced access technologies.

### SUMMARY

According to an aspect of the disclosure, a communication method performed by a terminal in a communication system is provided. The terminal determines multiple quasi co-location (QCL) information and information indicating a transmission state corresponding to a same downlink signal. The terminal measures and estimates a downlink channel state according to the determined multiple QCL information. The terminal demodulates the same downlink signal according to the information of multiple QCL, the information indicating the transmission state, and the downlink channel state.

According to another aspect of the disclosure, a terminal in a communication system is provided. The terminal includes a transceiver and a processor coupled with the transceiver. The processor is configured to determine multiple QCL information and information indicating a transmission state corresponding to a same downlink signal. The processor is also configurated to measure and estimate, a downlink channel state according to the determined multiple QCL information. The processor is further configured to demodulate the same downlink signal according to the determined multiple QCL information, the information indicating the transmission state, and the downlink channel state.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a flowchart illustrating a communication method, according to an embodiment;

FIG. 2 is a diagram illustrating a configuration method of multiple QCL, according to an embodiment;

FIG. 3 is a diagram illustrating another configuration method of multiple QCL, according to an embodiment;

FIG. 4 is a diagram illustrating another configuration method of multiple QCL, according to an embodiment;

FIG. 5 is a diagram illustrating a terminal, according to an embodiment; and

FIG. 6 is a diagram illustrating a terminal, according to an embodiment.

### DETAILED DESCRIPTION

Embodiments of the disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the disclosure.

In Long Term Evolution (LTE) and New Radio (NR) wireless communication systems, a high speed train scenario is a very important deployment scenario. Considering the increasing demand for high data rates in the high speed train scenario, in order to ensure the experience of users, LTE and NR systems have performed specific research on wireless communication in the high speed train scenario, and defined special new features to optimize wireless communication performance in the high speed train scenario. At present, a deployment scenario of high speed train transmission mainly considers: high speed train-single transmission point transmission (HST-Single Tap); and high speed train multi-point single frequency transmission (FIST-single frequency network (SFN)).

At present, performance of NR for the high speed train scenario is mainly defined for a scenario deployed with a frequency range that is less than a frequency band of 3 GHz and the velocity less than 500 km/h.

Demodulation of uplink and downlink received signals in the high speed train scenario brings great challenges, especially in estimation and compensation of Doppler frequency offset. In current NR systems, channel characteristic parameters (e.g., Doppler offset) of downlink signals are measured and estimated based on a tracking reference signal (TRS) signal. In the relevant definition, a position of a current TRS in a time domain is fixed, and the interval between adjacent reference signals in the time domain is fixed as 4 time-domain symbols.

However, the design of current TRS has limitations in the scenario supporting higher speed (e.g., a high speed maglev train with greater than 800 km/h velocity) and the high speed train scenario deployed in millimeter-wave bands.

On the other hand, NR defines a concept of quasi co-location (QCL) and a concept of transmission configuration indicator (TCI) state. The NR defines reference signal resource information (e.g., TRS) for measurement of quasi co-location information. The NR defines a corresponding relationship between the TCI state and the reference signal resource. A user equipment performs demodulation of the downlink signals based on the TCI state configuration and indication.

Release-16 (Rel-16) eMIMO WI supports multi-point correlation transmission (Multi-TRP), where different downlink signals correspond to different TCI states. In the current design of HST-SFN systems, the terminal is required to perform specific channel estimation, and specifically, estimation and compensation of the Doppler frequency offset, which increases the complexity of a terminal receiver and also affects demodulation performance of the downlink signals.

The current system does not support optimization for special transmission schemes in a SFN scenario. For example, the current system does not support the configuration of multiple quasi co-location information or multiple TCI states for the same downlink signal, as well as transmission of the same downlink signal on the same time-frequency resources at multiple transmission points simultaneously (i.e., spatial multiplexing).

The current system still has the following problems. First, the current tracking reference signal (TRS) cannot support measurement and estimation of channel characteristic parameters such as Doppler offset in a millimeter wave high speed scenario and a high speed scenario with the operation frequency below 60 Hz and the velocity higher than 500 km/h. Second, the current QCL and TCI state configuration cannot support a multi-point transmission (multi-TRP) in which the same downlink signal corresponds to multiple QCL assumptions. Third, in a high speed SFN scenario, there is no assistant information for the LTE receiver to demodulate the downlink signal, which increases complexity of the UE receiver and also impacts downlink demodulation performance.

For a downlink multi-point transmission scenario, the disclosure provides a communication method in which the same downlink signal corresponds to multiple QCL assumptions and a terminal device for performing the same.

A communication method performed by a terminal in a communication system is provided. The terminal determines multiple QCL information and information indicating a transmission state corresponding to a same downlink signal. The terminal measures and estimates a downlink channel state according to the multiple QCL information. The terminal demodulates the same downlink signal according to the determined multiple QCL information, the information indicating the transmission state, and the downlink channel state.

Optionally, determining the multiple QCL information and the information indicating the transmission state includes receiving, by the terminal, the multiple QCL information and the information indicating the transmission state corresponding to the same downlink signal configured by a base station.

Optionally, determining the multiple QCL information includes receiving, by the terminal, information indicating a set of transmission configuration indicator state (TCI state) information corresponding to the same downlink signal, to determine the multiple QCL information. The set of transmission configuration indicator state information includes one or more transmission configuration indicator state information corresponding to the same downlink signal. Each of the one or more transmission configuration indicator state information is associated with a different QCL information, respectively.

Optionally, determining the multiple QCL includes receiving, by the terminal, information indicating transmission configuration indicator state information corresponding to the same downlink signal, to determine of the multiple QCL information. The transmission configuration indicator state information is associated with one or more QCL information.

Optionally, determining the multiple QCL information includes receiving information indicating one or more transmission configuration indicator (TCI) state information corresponding to the same downlink signal, and receiving an indication indicating that the one or more transmission configuration indicator state information are associated with the same downlink signal, to determine the information of multiple QCL information. Each of the one or more transmission configuration indicator state information is associated with different QCL information, respectively.

Optionally, determining the information indicating the transmission state indication includes receiving one or more of the following information associated with the same downlink signal: downlink transmission scheme indication information, downlink repetition transmission scheme indication information, and downlink transmission scenario indication information.

Optionally, the downlink transmission scheme indication information indicates a downlink transmission scheme corresponding to the same downlink signal, wherein the downlink transmission scheme includes one or more of: a first single frequency network transmission (SFN) scheme, where the same downlink signal corresponds to multiple QCL information; a second single frequency network transmission (SFN) scheme, where different downlink signals correspond to different QCL information, respectively; and a third single frequency network transmission scheme, where the same downlink signal corresponds to the same QCL information, and the same downlink signal is from multiple transmission points.

Optionally, the downlink repetition transmission scheme indication information indicates a downlink repetition transmission scheme corresponding to the same downlink signal, where the downlink repetition transmission scheme includes one or more of: a first spatial multiplexing repetition transmission scheme, where a repetition transmission is performed through the same downlink reference signal port, and where the same downlink reference signal port corresponds to the multiple QCL information; and a second spatial multiplexing repetition transmission scheme, where the repetition transmission is performed through different downlink signal ports, and where the different downlink signal ports correspond to different QCL, information.

Optionally, the downlink transmission scenario indication information indicates a downlink transmission scenario corresponding to the same downlink signal, where the downlink transmission scenario includes one or more of: a high speed train-single tap transmission scenario (HST-single tap); a first high speed train-single frequency network transmission scenario (HST-SFN), wherein the same downlink signal corresponds to the multiple QCL information; a second high speed train single frequency network transmission scenario (HST-SFN), where different downlink signals correspond to different QCL information, respectively; and a third high speed train-single frequency network transmission scenario (HST-SFN), where the same downlink signal corresponds to the same QCL information, and the same downlink signal is from multiple transmission points.

Optionally, the multiple QCL information includes configuration information of a set of reference signals corresponding to the same downlink signal, wherein the set of reference signals includes multiple reference signal resources, and wherein positions of the multiple reference signal resources in time domain are fixed and configurable.

Optionally, the multiple QCL information includes configuration information of a set of reference signals corresponding to the same downlink signal, wherein the set of reference signals includes multiple reference signal resources, and wherein the interval between adjacent reference signal resources in a time domain is fixed and configurable.

Optionally, determining the multiple QCL information to the same downlink signal includes: receiving an indication indicating time-domain positions of the multiple reference resources: and determining the multiple QCL information corresponding to the same downlink signal based on the indication.

Optionally, determining the multiple QCL information to a downlink signal includes: receiving a first indication indicating the time-domain position of the first reference signal resource of the multiple reference signal resources in the time domain; receiving a second indication indicating an interval between adjacent reference signal resources in the time domain; and determining the multiple QCL information corresponding to the same downlink signal based on the first indication and the second indication.

Optionally, the interval between the adjacent reference signal resources of the multiple reference resources in the time domain is 2, 3 or 4 time-domain symbols.

According to an embodiment, a terminal in a communication system is provided, including a receiving module, a measurement module and a demodulation module. The receiving module is configured to determine multiple QCL information and information indicating a transmission state corresponding to a same downlink signal. The measurement module is also configured to measure and estimate a downlink channel state according to the determined multiple QCL. The demodulation module is further configured to demodulate the same downlink signal according to the determined multiple QCL, the information indicating the transmission state, and the downlink channel state.

According to an embodiment, a terminal in a communication system is provided, including a transceiver and a processor. The transceiver is configured to transmit and receive signals with outside. The processor is configured to control the transceiver to perform the communication method according to an embodiment.

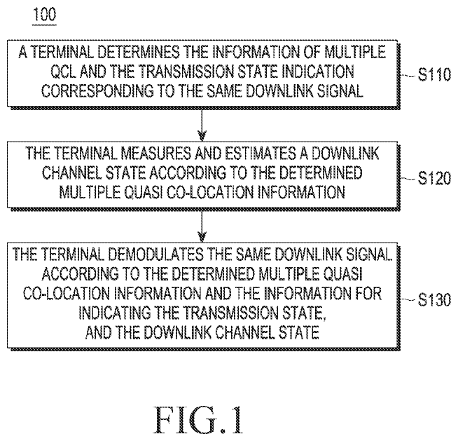

FIG. 1 is a flowchart illustrating a communication method, according to an embodiment.

Specifically, FIG. 1 illustrates a schematic flowchart 100 of a communication method in which a downlink signal is transmitted at multiple transmission points (multi-TRP) and the same downlink signal corresponds to multiple QCL information.

As shown in FIG. 1, in step S110, a terminal determines the information of multiple QCL and the transmission state indication corresponding to the same downlink signal. For example, the terminal may receive the information of multiple QCL and the transmission state indication corresponding to the same downlink signal configured by a base station, through downlink signaling, for example.

In step S110, the terminal may receive information of a set of transmission configuration indicator state (TO state) corresponding to the same downlink signal, to determine the multiple QCL information. The set of transmission configuration indicator state (TCI state) may include one or more transmission configuration indicator state (e.g., TCI state) corresponding to the same downlink signal, and each of the one or more transmission configuration indicator state may be associated with different quasi co-location information respectively,

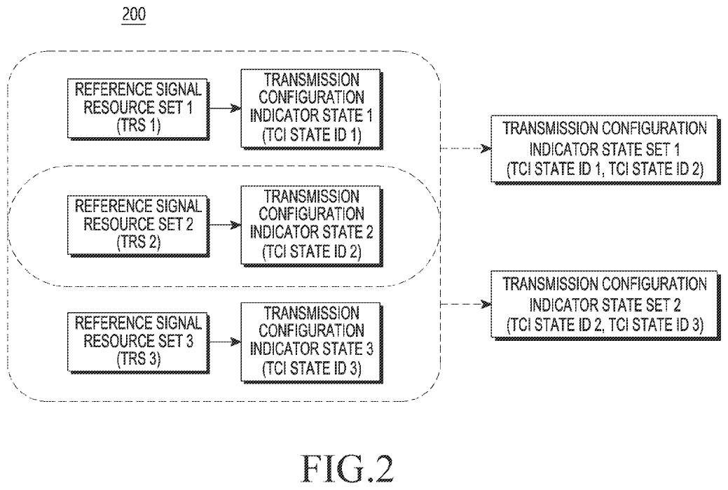

FIG. 2 is a diagram illustrating a configuration method of multiple QCL information, according to an embodiment.

As shown in diagram 200 of FIG. 2, three transmission configuration indicator states (TCI state) corresponding to the same downlink signal are shown, for example, transmission configuration indicator state 1 (TCI state 1), transmission configuration indicator state 2 (TCI state 2) and transmission configuration indicator state 3 (TCI state 3). TCI state 1 may indicate quasi co-location information associated with a reference signal resource set 1 (e.g., TRS 1), TCI state 2 may indicate quasi co-location information associated with a reference signal resource set 2 (e.g., TRS 2), and TCI state 3 may indicate quasi co-location information associated with a reference signal resource set 3 (e.g., TRS 3). Transmission configuration indicator state information indicating different quasi co-location information may be combined, and each set of transmission configuration indicator state information may be numbered. For example, TCI state 1 and TCI state 2 may be combined into a first set of transmission configuration indicator state information and numbered as transmission configuration indicator state information set 1. TCI state 2 and TCI state 3 may be combined into a second set of transmission configuration indicator state information and numbered as transmission configuration indicator state information set 2. The terminal may determine or receive information (e.g., a number of the set or index information) indicating a set of transmission configuration indicator state information corresponding to the same downlink signal, through downlink signaling, for example, so that it may determine the multiple QCL information corresponding to the downlink signal.

Referring back to FIG. 1, in step S110, the terminal may receive information indicating transmission configuration indicator state information corresponding to the same downlink signal, to determine multiple QCL information. The transmission configuration indicator state information may be associated with one or more quasi co-location information.

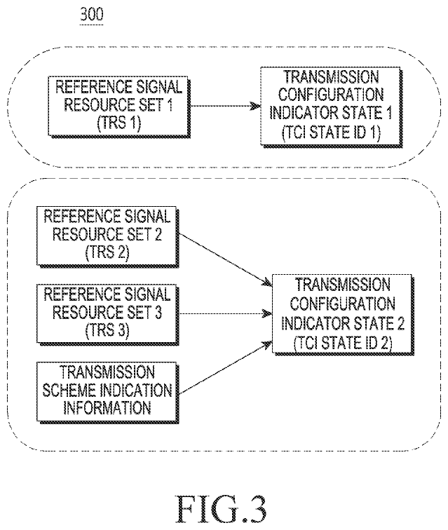

FIG. 3 is a diagram illustrating another configuration method of multiple QCL information, according to an embodiment.

Specifically, a diagram 300 of FIG. 3 shows two transmission configuration indicator states, for example, transmission configuration indicator state 1 (TCI state 1) and transmission configuration indicator state 2 (TCI state 2). A transmission configuration indicator state may be associated with one or more quasi co-location information. For example, as shown in FIG. 3, TCI state 1 may be associated with quasi co-location information corresponding to reference signal resource set 1 (e.g., TRS 1), and TO state 2 may be associated with quasi co-location information corresponding to reference signal resource set 2 (e.g., TRS 2) and reference signal resource set 3 (e.g., TRS 3). The terminal may receive information indicating transmission configuration indicator state information (e.g., an ID of a TCI state) corresponding to a downlink signal, so that multiple QCL information corresponding to the same downlink signal may be determined. For example, in the embodiment shown in FIG. 3, when the terminal receives a TCI State with an ID of 2 (i.e., TCI state 2), the terminal may determine multiple QCL information associated with IRS 2 and TRS 3. In addition, as shown in FIG. 3, when a transmission configuration indicator state is associated with multiple quasi co-location information, downlink transmission scheme indication information associated with the downlink signal may be also included in the transmission configuration indicator state, which will be described in greater detail below.

Referring back to FIG. 1, in step S110, the terminal may receive information indicating one or more transmission configuration indicator state information corresponding to the same downlink signal, and may receive an indication indicating that the one or more transmission configuration indicator state information is associated with the same downlink signal, to determine the multiple QCL information. Each of the one or more transmission configuration indicator state information may be associated with different quasi co-location information, respectively.

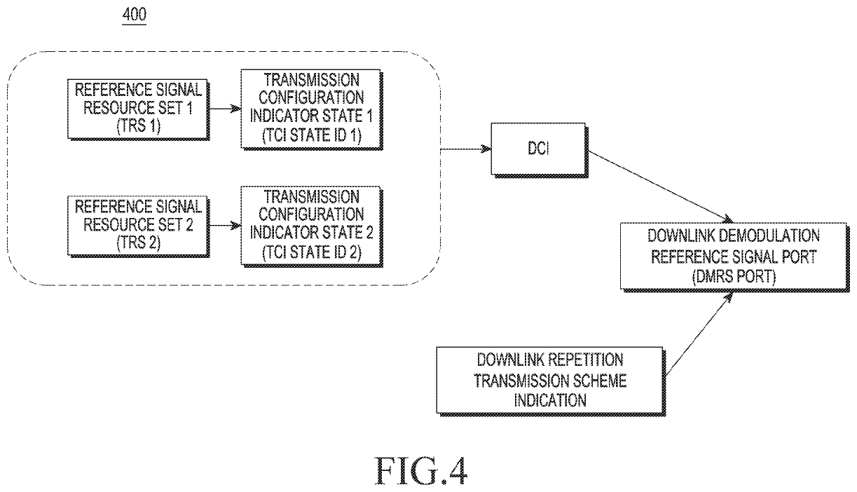

FIG. 4 is a diagram illustrating another configuration method of multiple quasi co-location information, according to an embodiment.

As shown in FIG. 4, two transmission configuration indicator states corresponding to the same downlink signal are shown, for example, transmission configuration indicator state 1 (TCI state 1) and transmission configuration indicator state 2 (TCI state 2). TCI state 1 may indicate quasi co-location information associated with reference signal resource set 1 (e.g., TRS 1), and TCI state 2 may indicate quasi co-location information associated with reference signal resource set 2 (e.g., TRS 2). A terminal may receive information indicating TCI state 1 and TCI state 2 (e.g., TCI state IDs 1 and 2 thereof), and may receive an indication indicating that both TCI state 1 and TCI state 2 are associated with the same downlink signal, through DCI, for example, so that the terminal may determine multiple QCL information in which the current downlink signal (e.g., a physical downlink shared channel (PDSCH) or downlink dedicated demodulation signal (DMRS)) is in a quasi co-location relationship with both TRS 1 and TRS 2. In addition, as shown in FIG. 4, in addition to receiving the indication indicating that both TCI state 1 and TCI state 2 are associated with the downlink signal, the terminal may also receive downlink repetition transmission scheme indication information associated with the downlink signal, which will be described in greater detail below.

According to a configuration method of multiple quasi co-location information, multiple quasi co-location assumption information or multiple TCI states may be configured for the same downlink signal, so that transmission and demodulation of the same downlink signal on the same time-frequency resource with multiple transmission points can be supported.

Referring back to FIG. 1, in step S110, the terminal determining transmission configuration (e.g., information for indicating a transmission state, or transmission state indication) corresponding to a downlink signal may include receiving one or more of the following information associated with the same downlink signal: downlink transmission scheme indication information, downlink repetition transmission scheme indication information, and downlink transmission scenario indication information, and the like.

The downlink transmission scheme indication information may indicate a downlink transmission scheme corresponding to the same downlink signal. The downlink transmission scheme may include one or more of: a first single frequency network transmission scheme in which the same downlink signal may correspond to multiple quasi co-location information; a second single frequency network transmission scheme in which different downlink signals may, correspond to different quasi co-location information respectively; and a third single frequency network transmission scheme in which the same downlink signal may correspond to the same quasi co-location information and the same downlink signal is from multiple transmission points. By indicating the downlink transmission scheme corresponding to the downlink signal, more assistant information may be provided for the terminal for demodulation of the downlink signal, so that complexity of the terminal may be reduced.

The downlink repetition transmission scheme indication information may indicate a downlink repetition transmission scheme corresponding to the same downlink signal. The downlink repetition transmission scheme may include one or more of: a first spatial multiplexing repetition transmission scheme in which a repetition transmission may be performed through the same downlink signal port (e.g., DMRS port), where the same downlink signal port may correspond to multiple Quasi co-location information; and a second spatial multiplexing repetition transmission scheme in which a repetition transmission may be performed through different downlink signal ports, where the different downlink signal ports may correspond to different Quasi co-location information. Similarly, by indicating the downlink repetition transmission scheme corresponding to the downlink signal, more assistant information may be provided for the terminal for demodulation of the downlink signal, so that complexity of the terminal may be reduced.

The downlink transmission scenario indication information may indicate a downlink transmission scenario corresponding to the same downlink signal. The downlink transmission scenario may include one or more of: a HST single-tap; a first HST SFN in which the same downlink signal may be associated with multiple quasi co-location information; a second HST SFN in which different downlink signals may be associated with different quasi co-location information respectively; and a third HST SFN in which the same downlink signal may be associated with the same quasi co-location information and the same downlink signal is from multiple transmission points. By indicating the downlink transmission scenario corresponding to the downlink signal, more assistant information may be provided for the terminal for demodulation of the downlink signal, so that complexity of the terminal may be reduced. In the above-described embodiments, several HST transmission scenarios are enumerated without limitation, and it should be understood that the downlink transmission scenario may also include any other non-HST transmission scenarios, which are not limited herein.

In step S110, multiple QCL information corresponding to the same downlink signal determined by the terminal may include configuration information of a set of reference signals corresponding to the same downlink signal. The set of reference signals may include multiple reference signal resources, and positions of the multiple reference signal resources in time domain may be fixed and configurable. Optionally, in step S110, the multiple quasi co-location information corresponding to the same downlink signal determined by the terminal may include configuration information of a set of reference signals corresponding to the same downlink signal. The set of reference signals may include multiple reference signal resources, and an interval between adjacent reference signal resources of the multiple reference signal resources in the time domain may be fixed and configurable, as shown in Table 1.

TABLE 1

| Time-domain interval | |
|---|---|
| delta_L between | |
| adjacent reference | |
| signal resources | Specific time-domain location information |
| Delat_L = 2 | l ∈ {0,2}, l ∈ {1,3}, l ∈ {2,4}, l ∈ {3,5}, |
| | l ∈ {4,6}, l ∈ {5,7}, l ∈ {6,8}, l ∈ {7,9}, |
| | l ∈ {8,10}, l ∈ {9,11}, l ∈ {10,12}, |
| | l ∈ {11,13}, |
| Delat_L = 3 | l ∈ {0,3}, l ∈ {1,4}, l ∈ {2,5}, l ∈ {3,6}, |
| | l ∈ {4,7}, l ∈ {5,8}, l ∈ {6,9}, l ∈ {7,10}, |
| | l ∈ {8,11}, l ∈ {9,12}, l ∈ {10,13} |
| Delat_L = 4 | l ∈ {0,4}, l ∈ {1,5}, l ∈ {2,6}, l ∈ {3,7}, |
| | l ∈ {4,8}, l ∈ {5,9}, l ∈ {6,10}, l ∈ {8,12}, |
| | l ∈ {9,13} |

Table 1 shows time-domain location information of the reference signal resources when the time-domain location interval delta_L between the adjacent reference signal resources is 2, 3 or 4 time-domain symbols, respectively. The time-domain location information shown in Table 1 is only an example, and any other suitable time-domain location interval may be adopted for the adjacent reference signal resources.

Determining multiple quasi co-location information corresponding to the same downlink signal may include receiving an indication indicating time-domain positions of the multiple reference signal resources in the time domain, and determining the multiple quasi co-location information associated with the same downlink signal based on the position indication. For example, the terminal may receive indication information for a specific time-domain position of each of the multiple reference signal resources in the time domain. Optionally, determining multiple quasi co-location information corresponding to the same downlink signal may include: receiving a first indication indicating a time-domain position of the first reference signal resource of the multiple reference signal resources in the time domain, receiving a second indication indicating the interval between the adjacent reference signal resources in the time domain, and determining the multiple Quasi co-location information associated to the same downlink signal based on the first indication and the second indication. For example, the terminal may receive indication information for a specific time-domain position of a starting reference signal resource of the multiple reference signal resources, and receive an indication indicating an interval between the adjacent reference signal resources in the time domain, so that a position of each reference signal resource in the time domain may be derived based on the specific time-domain position of the starting reference signal resource and the interval between the adjacent reference signal resources in the time domain.

By adopting a configurable time-domain interval between the adjacent reference signal resources shown in Table 1, a transmission cycle of the reference signal resources may be flexibly adjusted (e.g., by adjusting the time-domain interval between the adjacent reference signal resources), so that it can be applied to a HST transmission scenario with a higher speed.

Referring back to FIG. 1, in step S120, the terminal measures and estimates a downlink channel state according to the determined multiple quasi co-location information. Optionally, the terminal may also measure and estimate a downlink channel state according to the determined multiple quasi co-location information and the information for indicating the transmission state. In step S130, the terminal demodulates the same downlink signal according to the determined multiple quasi co-location information and the information for indicating the transmission state, and the downlink channel state. It should be understood that any existing or future channel measurement and estimation technology and downlink demodulation technology may be adopted to measure and estimate the downlink channel state and demodulate the downlink signal, which is not limited herein.

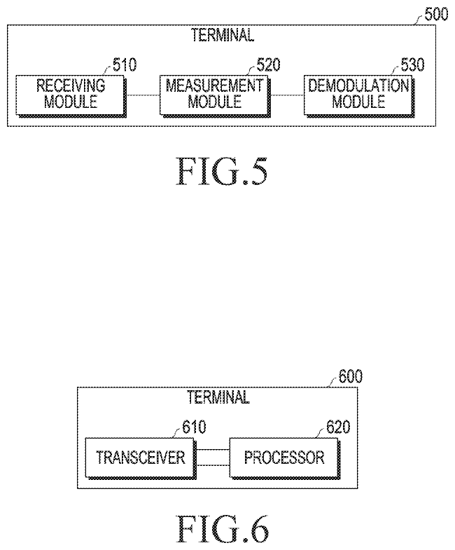

FIG. 5 is a diagram illustrating a terminal, according to an embodiment.

As shown in FIG. 5, a terminal 500 includes a receiving module 510, a measurement module 520 and a demodulation module 530. The terminal 500 may implement a communication method in a multi-transmission point scenario according to the above-described embodiments. For example, the receiving module 510 may be configured to determine multiple quasi co-location information and information of transmission configuration (i.e., information for indicating a transmission state, or transmission state indication) corresponding to the same downlink signal. The measurement module 520 may be configured to measure and estimate a downlink channel state according to the determined multiple quasi co-location information. The demodulation module 530 may be configured to demodulate the same downlink signal according to the determined multiple quasi co-location information and the information for indicating the transmission state, and the downlink channel state.

The terminal 500 may receive, through the receiving module 510, information of a set of transmission configuration indicator state information corresponding to the same downlink signal, to determine the multiple Quasi co-location information. The set of transmission configuration indicator state information may include one or more transmission configuration indicator state information (e.g., TCI state) corresponding to the same downlink signal, and each of the one or more transmission configuration indicator state information may be associated with different quasi co-location information, respectively.

The terminal 500 may receive, through the receiving module 510, information indicating transmission configuration indicator state information corresponding to the same downlink signal, to determine the multiple quasi co-location information. The transmission configuration indicator state information may be associated with one or more quasi co-location information.

The terminal 500 may receive, through the receiving module 510, information indicating one or more transmission configuration indicator state information corresponding to the same downlink signal, and may receive an indication indicating that the one or more transmission configuration indicator state information is associated with the same downlink signal, to determine the multiple quasi co-location information. Each of the one or more transmission configuration indicator state information may be associated with different quasi co-location information, respectively.

Optionally, the terminal 500 may receive, through the receiving module 510, one or more of the following information associated with the same downlink signal: downlink transmission scheme indication information, downlink repetition transmission scheme indication information, and downlink transmission scenario indication information.

The downlink transmission scheme indication information may indicate a downlink transmission scheme corresponding to the same downlink signal. The downlink transmission scheme may include one or more of: a first single frequency network transmission scheme in which the same downlink signal may correspond to the multiple quasi co-location information; a second single frequency network transmission scheme in which different downlink signals may, correspond to different quasi co-location information respectively; and a third single frequency network transmission scheme in which the same downlink signal may correspond to the same quasi co-location information and the same downlink signal is from multiple different transmission points. By indicating the downlink transmission scheme corresponding to the same downlink signal, more assistant information may be provided for the terminal for demodulation of the downlink signal, so that complexity of the terminal may be reduced.

The downlink repetition transmission scheme indication information may indicate a downlink repetition transmission scheme corresponding to the same downlink signal. The downlink repetition transmission scheme may include one or more of: a first spatial multiplexing repetition transmission scheme in which a repetition transmission may be performed through the same downlink signal port (e.g., MARS port), where the same downlink signal port may correspond to the multiple quasi co-location information; and a second spatial multiplexing repetition transmission scheme in which a repetition transmission may be performed through different downlink signal ports, where the different downlink signal ports may correspond to different quasi co-location information. Similarly, by indicating the downlink repetition transmission scheme corresponding to the downlink signal, more assistant information may be provided for the terminal for demodulation of the downlink signal, so that complexity of the terminal may be reduced.

The downlink transmission scenario indication information may indicate a downlink transmission scenario corresponding to the same downlink signal. The downlink transmission scenario may include one or more of: a high speed train-single tap transmission scenario; a first high speed train-single frequency network transmission scenario in which the same downlink signal may be associated with the multiple quasi co-location information; a second high speed train-single frequency network transmission scenario in which different downlink signals may be associated with different quasi co-location information respectively; and a third high speed train-single frequency network transmission scenario in which the same downlink signal may be associated with the same quasi co-location information and the same downlink signal is from multiple different transmission points. By indicating the downlink transmission scenario corresponding to the downlink signal, more assistant information may be provided for the terminal for demodulation of the downlink signal, so that complexity of the terminal may be reduced. In the above embodiments, several HST transmission scenarios are enumerated without limitation, and it should be understood that the downlink transmission scenario may also include any other non-high speed train transmission scenarios, which are not limited herein.

The multiple quasi co-location information corresponding to the same downlink signal determined by the terminal may include configuration information of a set of reference signals corresponding to the same downlink signal. The set of reference signals may include multiple reference signal resources, and positions of the multiple reference signal resources in time domain may be fixed and configurable. Optionally, the multiple quasi co-location information corresponding to the same downlink signal determined by the terminal may include configuration information of a set of reference signals corresponding to the same downlink signal, where the set of reference signals may include multiple reference signal resources, and an interval between adjacent reference signal resources of the multiple reference signal resources in the time domain may be fixed and configurable, as shown in Table 1 above.

As described above, Table 1 shows time-domain location information of the reference signal resources when the time-domain location interval delta_L between the adjacent reference signal resources is 2, 3 or 4 time-domain symbols, respectively. The time-domain location information shown in Table 1 is only an example, and any other suitable time-domain location interval may be adopted for the adjacent reference signal resources.

Determining multiple quasi co-location information corresponding to the same downlink signal may include receiving an indication indicating time-domain positions of the multiple reference signal resources in the time domain, and determining the multiple quasi co-location information corresponding to the same downlink signal based on the position indication. For example, the terminal may receive indication information for a specific time-domain position of each of the multiple reference signal resources in the time domain. Optionally, determining multiple quasi co-location information corresponding to the same downlink signal may include: receiving a first indication indicating a time-domain position of a first reference signal resource of the multiple reference signal resources in the time domain, and receiving a second indication indicating an interval between the adjacent reference signal resources in the time domain, and determining the multiple quasi co-location information corresponding to the same downlink signal based on the first indication and the second indication. For example, the terminal may receive indication information for a specific time-domain position of a starting reference signal resource of the multiple reference signal resources, and receive an indication indicating an interval between the adjacent reference signal resources in the time domain, so that a position of each reference signal resource in the time domain may be derived based on the specific time-domain position of the starting reference signal resource and the interval between the adjacent reference signal resources in the time domain.

By adopting a configurable time-domain interval between the adjacent reference signal resources shown in Table 1, a transmission cycle of the reference signal resources may be flexibly adjusted (e.g., by adjusting the time-domain interval between the adjacent reference signal resources), so that it can be applied to a HST transmission scenario with a higher speed.

FIG. 6 is a diagram illustrating a terminal, according to an embodiment. As shown in FIG. 6, a terminal 600 includes a transceiver 610 and a processor 620. The transceiver 610 may be configured to transmit and receive signals. The processor 620 may be configured to control the transceiver 610 to perform the communication method according to the above-described embodiments. For example, the processor 620 may be configured to receive, through the transceiver 610, multiple quasi co-location information and information for indicating a transmission state corresponding to a downlink signal; measure and estimate a downlink channel state according to the determined plurality of quasi co-location information; and demodulate the same downlink signal according to the determined plurality of quasi co-location information and the information for indicating the transmission state, and the downlink channel state.

Various embodiments of the disclosure may be implemented as computer readable codes embodied on a computer readable recording medium from a specific perspective. The computer readable recording medium is any data storage device that may store data readable by a computer system. An example of the computer readable recording medium may include a read-only memory (ROM), a random access memory (RAM), a compact disk read-only memory (CD-ROM), a magnetic tape, a floppy disk, an optical data storage device, a carrier wave (e.g., data transmission via an Internet), and the like. Computer readable recording media may be distributed by computer systems connected via a network, and thus the computer readable codes may be stored and executed in a distributed manner. Furthermore, functional programs, codes, and code segments for implementing various embodiments of the disclosure may be easily explained by those skilled in the art to which the embodiments of the disclosure are applied.

It will be understood that the embodiments of the disclosure may be implemented in a form of hardware, software, or a combination of hardware and software. Software may be stored as program instructions or computer readable codes executable on a processor on a non-transitory computer readable medium. An example of the non-transitory computer readable recording medium includes a magnetic storage medium (e.g., a ROM, a floppy disk, a hard disk, etc.) and an optical recording medium (e.g., a CD-ROM, a digital video disk (DVD), etc.). Non-transitory computer readable recording media may also be distributed on computer systems coupled by a network, so that the computer readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer readable recording medium suitable for storing program(s) having instructions to implement the embodiments of the disclosure. The disclosure may be realized by a program having codes for specifically implementing the apparatus and method described in the claims, which is stored in a machine (or computer) readable storage medium. The program may be electronically carried on any medium, such as a communication signal transferred via a wired or wireless connection, and the disclosure suitably includes equivalents thereof.

The above descriptions are only specific implementations of the disclosure, but a protection scope of the disclosure is not limited to this. Any technician familiar with the technical field may make various changes or substitutions within a technical scope revealed in the disclosure, and these changes or substitutions should be covered within the protection scope of the disclosure. Therefore, the protection scope of the disclosure should be subject to a protection scope of the appended claims and their equivalents.

What is claimed is:

1. A communication method performed by a terminal in a communication system, the communication method comprising:
determining, by the terminal, multiple quasi co-location (QCL) information and information indicating a transmission state corresponding to a same downlink signal;
measuring and estimating, by the terminal, a downlink channel state according to the determined multiple QCL information; and
demodulating, by the terminal, the same downlink signal according to the determined multiple QCL information, the information indicating the transmission state, and the downlink channel state.

2. The communication method of claim 1, wherein determining the multiple QCL information and the information indicating the transmission state comprises:
receiving, by the terminal, the multiple QCL information and the information indicating the transmission state corresponding to the same downlink signal configured by a base station.

3. The communication method of claim 1, wherein determining the multiple QCL information comprises:
receiving, by the terminal, information indicating a set of transmission configuration indicator state (TCI state) information corresponding to the same downlink signal, to determine the multiple QCL information,
wherein the set of transmission configuration indicator state information includes one or more transmission configuration indicator state information corresponding to the same downlink signal, and
wherein each of the one or more transmission configuration indicator state information is associated with a different piece of QCL information, respectively.

4. The communication method of claim 1, wherein determining the multiple QCL information comprises:
receiving, by the terminal, information indicating transmission configuration indicator state information associated with the same downlink signal, to determine multiple QCL information,
wherein the transmission configuration indicator state information is associated with one or more QCL information.

5. The communication method of claim 1, wherein determining the multiple QCL information comprises:
receiving, by the terminal, information indicating one or more transmission configuration indicator state information corresponding to the same downlink signal, and receiving an indication indicating that the one or more transmission configuration indicator state information are associated with the same downlink signal, to determine the multiple QCL information,
wherein each of the one or more transmission configuration indicator state information is associated with different QCL information, respectively.

6. The communication method of claim 1, wherein determining the information indicating the transmission state comprises receiving one or more of the following information associated with the same downlink signal:
downlink transmission scheme indication information, downlink repetition transmission scheme indication information, and downlink transmission scenario indication information.

7. The communication method of claim 6, wherein the downlink transmission scheme indication information indicates a downlink transmission scheme corresponding to the same downlink signal, and wherein the downlink transmission scheme comprises one or more of:
a first single frequency network (SFN) transmission scheme, wherein the same downlink signal is associated with multiple QCL information;
a second SFN transmission scheme, wherein different downlink signals are associated with different QCL information, respectively; and
a third SFN transmission scheme, wherein the same downlink signal is associated with the same QCL information, and the same downlink signal is from multiple transmission points.

8. The communication method of claim 6, wherein the downlink repetition transmission scheme indication information indicates a downlink repetition transmission scheme corresponding to the same downlink signal, and wherein the downlink repetition transmission scheme comprises one or more of:
a first spatial multiplexing repetition transmission scheme, wherein a repetition transmission is performed through a same downlink signal port, and wherein the same downlink signal port associated with multiple QCL information; and
a second spatial multiplexing repetition transmission scheme, wherein the repetition transmission is performed through different downlink signal ports, and wherein the different downlink signal ports correspond to different QCL information.

9. The communication method of claim 6, wherein the downlink transmission scenario indication information indicates a downlink transmission scenario corresponding to the same downlink signal, wherein the downlink transmission scenario comprises one or more of:
a high speed train-single tap (HST single Tap) transmission scenario;
a first high speed train-single frequency network transmission scenario, wherein the same downlink signal is associated with multiple QCL information;
a second high speed train-single frequency network transmission scenario, wherein different downlink signals are associated with different QCL information respectively; and
a third high speed train-single frequency network transmission scenario, wherein the same downlink signal is associated with the same QCL information, and the same downlink signal is from multiple transmission points.

10. The communication method of claim 1, wherein the multiple QCL information comprises configuration information of a set of reference signals corresponding to the same downlink signal, wherein the set of reference signals includes multiple reference signal resources, and wherein positions of the multiple reference signal resources in time domain are fixed and configurable.

11. The communication method of claim 1, wherein the multiple QCL information includes configuration information of a set of reference signals corresponding to the same downlink signal, wherein the set of reference signals includes multiple reference signal resources, and wherein an interval between adjacent reference signal resources of the multiple reference signal resources in a time domain are fixed and configurable.

12. The communication method of claim 10, wherein determining the multiple QCL information corresponding to the same downlink signal comprises:
receiving an indication indicating time-domain positions of multiple reference signal resources in the time domain; and
determining the multiple QCL information associated with the same downlink signal based on the indication.

13. The communication method of claim 10, wherein determining the multiple QCL information corresponding to a downlink signal comprises:
receiving a first indication indicating a time-domain position of a first reference signal resource of the multiple reference signal resources in the time domain;
receiving a second indication indicating an interval between adjacent reference signal resources in the time domain; and
determining the multiple QCL information corresponding to the same downlink signal based on the first indication and the second indication.

14. The communication method of claim 11, wherein the interval between the adjacent reference signal resources of multiple reference signal resources in the time domain is 2, 3 or 4 time-domain symbols.

15. A terminal in a communication system, comprising:
a transceiver; and
a processor coupled with the transceiver and configured to:
determine multiple quasi co-location (QCL) information and information indicating a transmission state corresponding to a same downlink signal,
measure and estimate a downlink channel state according to the determined multiple QCL information, and
demodulate the same downlink signal according to the determined multiple QCL information, the information indicating the transmission state, and the downlink channel state.
